(19) United States
(12) Patent Application Publication
(10) Pub. No.: US 2008/0008355 A1
(43) Pub. Date: Jan. 10, 2008

(54) Image recognition apparatus, image recognition method, and vehicle control apparatus

(75) Inventors: Keiko Okamoto, Hyogo (JP); Katsumi Sakata, Hyogo (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 11/822,232

(22) Filed: Jul. 3, 2007

(30) Foreign Application Priority Data
Jul. 5, 2006 (JP) 2006-185900
Jul. 5, 2006 (JP) 2006-185901

(51) Int. Cl. G06K 9/00

(52) U.S. Cl. 382/104; 382/103

(57) ABSTRACT

An extracting unit extracts a determination subject area from an input image shot by a camera. A recognition unit recognizes a presence of a specific object by comparing an image of the determination subject area with a reference image. An interval control unit controls an interval of an extracting position of the determination subject area to be extracted by the extracting unit based on a location of the determination subject area within the input image.

### TECHNICAL FIELD

The present invention relates to an image recognition apparatus for performing an image recognition on a specific object from an input image shot by a camera and an image recognition method, and more particularly, to an image recognition apparatus, an image recognition method, and a vehicle control apparatus for recognizing a pedestrian.

### BACKGROUND ART

While a vehicle is moving, a collision avoidance particularly from a pedestrian is of great importance. Therefore, a technology has been recently proposed to recognize a pedestrian around a vehicle by using an image recognition or a radar detection (see, for example, Patent Document 1).

When recognizing a pedestrian by the image recognition, a size of an image of a pedestrian to be shot changes depending on a distance from the vehicle to the pedestrian, and if different templates are prepared for every size of the image of the pedestrian, a volume of the templates becomes large. Therefore, it has been proposed that a subject image is to be compared with a template by enlarging/reducing a size of the subject image, as disclosed in, for example, Patent document 2.

[Patent document 1] Japanese Patent Laid-open Publication No. 2002-362302

[Patent document 2] Japanese Patent Laid-open Publication No. 2003-196655

### DISCLOSURE OF INVENTION

### Problem to be Solved by the Invention

However, conventionally, to find an area of which pattern is matched with a template image of a pedestrian, a search is performed by shifting pixel by pixel regardless of a location in the image, so that a large computing volume is required. As a result, there is a problem that a processing time required for the recognition of a pedestrian tends to be long.

On the other hand, possibilities of presence of a pedestrian in an image and a size of a figure vary from location to location in the image, which are not uniform. When recognizing a pedestrian from a vehicle in traveling, and using a recognition for avoidance of danger, reduction in a time needed until the recognition of the pedestrian is strongly required, so that challenges are to achieve more efficient processing by controlling a matching interval in accordance with a location in the image, and to reduce a computing volume while maintaining precision of the recognition of the pedestrian.

Furthermore, in the conventional technology that uses a template by enlarging/reducing a size of an image, if a size ratio between a subject image and a template is unknown, an optimal enlargement/reduction rate has to be found out by changing the rate for the image successively. Therefore, there is a problem that, even if the volume of templates is reduced, a processing load is increased and a processing time needed for pedestrian recognition is increased.

On the other hand, when recognizing a pedestrian, because a difference in clothes of pedestrians may affect recognition precision, an appropriate filtering to absorb such individual difference is needed.

In other words, the pedestrian recognition according to the conventional image processing has a problem that reduction in a volume of templates, enhancement of the processing speed, and improvement in recognition precision are not compatible to each other.

The present invention has been made to solve the problems in the conventional technology described above, and to resolve the challenges. An object of the present invention is to provide an image recognition apparatus, an image recognition method, and a vehicle control apparatus that reduce a computing volume while maintaining recognition precision, and achieve high speed and high precision, and to provide an image recognition apparatus and an image recognition method that enhance a processing speed while reducing the volume of templates, and improve recognition precision.

### EFFECT OF THE INVENTION

According to the present invention, the image recognition apparatus, the image recognition method, and the vehicle control apparatus extract a determination subject area in accordance with an interval or a size that varies based on a location in an image, and efficiently search for an area having a high possibility of presence of a specific object. As a result, an image recognition apparatus, an image recognition method, and a vehicle control apparatus that reduce a computing volume while maintaining recognition precision, and achieve high speed and high precision can be obtained.

Furthermore, according to the present invention, the image recognition apparatus and the image recognition method reduce a storage medium volume required for storing therein templates, increase patterns of templates if a storage medium has a sufficient capacity, and use the reduction processing as filtering for leaving out individual differences among pedestrians. As a result, an image recognition apparatus and an image recognition method that enhance the processing speed while reducing the volume of templates, and improve recognition precision can be obtained.

### DETAILED DESCRIPTION OF THE PREFERRED EMBODIMENTS

Exemplary embodiments of an image recognition apparatus, an image recognition method, and a vehicle control apparatus according to the present invention are explained in detail below with reference to the accompanying drawings. For simplifying explanations, a first embodiment is explained mainly about control of a cutting-out interval for a determination subject area, and a second embodiment is explained mainly about pattern matching over a determination subject area. When the present invention is implemented, each of the embodiments is not necessarily performed separately, but can be performed in combination with each other.

### First Embodiment

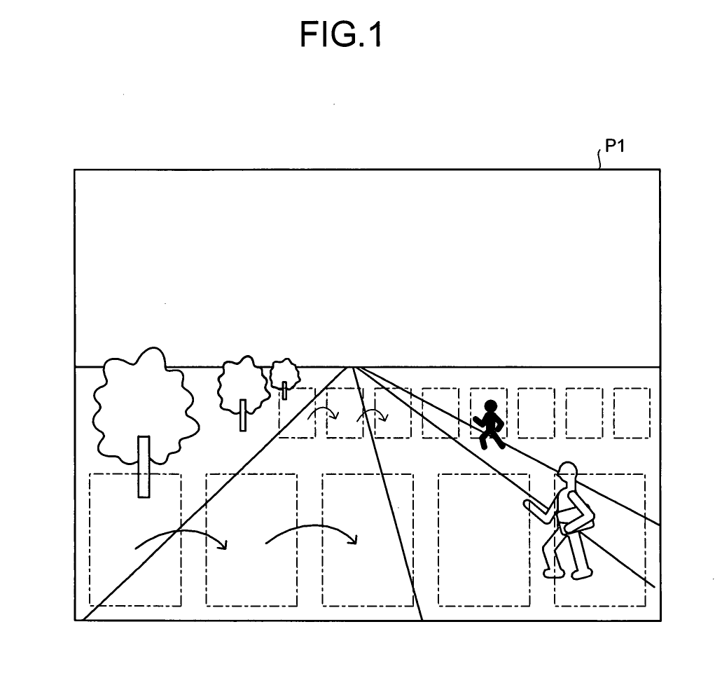

First of all, an image recognition method according to the first embodiment is explained below with reference to FIG. 1. In the first embodiment, when cutting-out a determination subject area from an image shot by a camera, an interval of cutting-out (extraction) is controlled based on a location of the determination subject area in an input image.

For example, in an image P1 shown in FIG. 1, if a determination area is cut out from a lower part in the image, the cutting-out interval is larger than a cutting interval when cutting-out from an upper part. The reason for this is because a pedestrian image appearing in the lower part in the image is a figure of a pedestrian in a location close to a vehicle in operation, the shorter distance between the vehicle and the pedestrian results in the larger size of the pedestrian image in the input image, so that even if the interval is large, a possibility of capturing part of the pedestrian image within a determination area is high (in contrast, a pedestrian image appearing in the upper part in the image is a figure of a pedestrian in a location far from the vehicle, and the size of the pedestrian image is relatively small, so that a cutting-out interval needs to be small, otherwise there is a possibility of omission from detection).

Thus, if the determination area cut out with a relatively large interval includes part of a pedestrian, a degree of matching with a template in accordance with a proportion of the part of the pedestrian image included in the determination area to the whole pedestrian image is obtained.

A determination subject area having a relatively high matching degree is then extracted, and shifted-matching is performed on surroundings of the extracted area, or the size of a cutting-out area is extended and pattern matching is again performed on the extended area, so that a determination subject area that contains the whole image of a pedestrian can be cut out.

In this way, the location of a pedestrian can be predicted from a location of the pedestrian in the image, and a cutting-out interval is controlled in accordance with a prediction result. For example, the interval of a search area close to the vehicle in operation is set large, and a search area far from the vehicle is set small. Accordingly, a pedestrian image can be efficiently obtained.

In terms of the size of a search area (a determination subject area), it is preferable to make matching to be easily taken by setting a large search area in the lower part of the image, and setting a small search area in the upper part of the image, in proportion as predicted the larger pedestrian image in the nearer location to the vehicle.

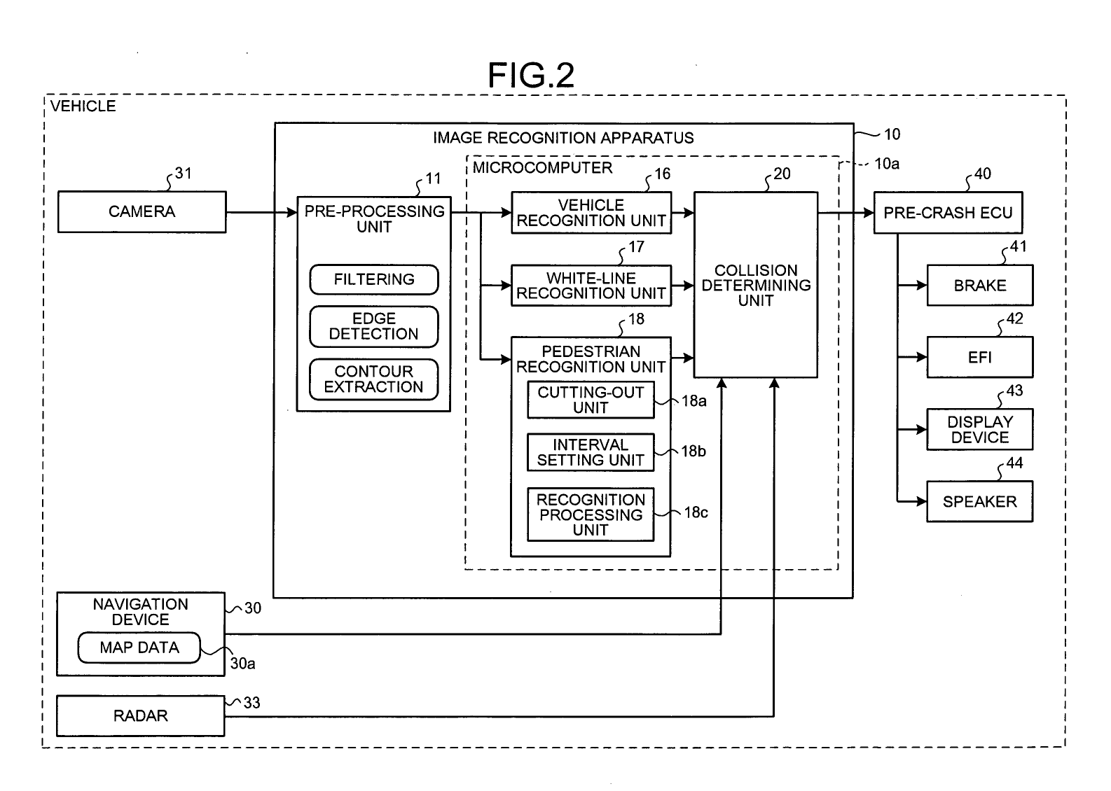

In the following description, an outline configuration of an image recognition apparatus 10 configured to be installed on a vehicle according to the first embodiment is explained with reference to FIG. 2. As shown in the figure, the image recognition apparatus 10 installed on a vehicle is connected to a navigation device 30, a camera 31, a radar 33, and a pre-crash electronic control unit (ECU) 40.

The navigation device 30 is an on-vehicle device that sets and guides a driving route by using a location of the vehicle specified by communicating with the GPS (Global Positioning System) and map data 30a that is stored in advance in the navigation device 30. Moreover, the navigation device 30 provides information to the image recognition apparatus 10, for example, positional information about the vehicle, map information about surroundings, and a planned driving route.

The camera 31 shoots surroundings of the vehicle, and inputs a shot result into the image recognition apparatus 10. The radar 33 detects an object around the vehicle, measures a distance to the object, and inputs the measured distance into the image recognition apparatus 10.

The pre-crash ECU 40 is an electronic control device that is to be controlled by the image recognition apparatus 10 when the image recognition apparatus 10 predicts a collision of the vehicle, and executes operation control of the vehicle with a brake 41 and an engine control device (EFI) 42, and notification with a display device 43 or a speaker 44.

The display device 43 is an output unit that gives a displayed notice to a user, i.e., an occupant in the vehicle, and the speaker 44 is an output unit that gives an audio notice. The display device 43 and the speaker 44 makes an output by receiving control from the pre-crash ECU 40, and can be shared by various on-vehicle devices, such as the navigation device 30, and an on-vehicle audio device, which is not shown.

The image recognition apparatus 10 includes therein a pre-processing unit 11, a vehicle recognition unit 16, a white-line recognition unit 17, a pedestrian recognition unit 18, and a collision determining unit 20. Here, it is preferable that the vehicle recognition unit 16, the white-line recognition unit 17, the pedestrian recognition unit 18, and the collision determining unit 20 are implemented, for example, by a single microcomputer 10a (a computing unit that includes a combination of a CPU, a ROM, and a RAM).

The pre-processing unit 11 performs processing, such as filtering, edge detection, and contour extraction, on an image shot by the camera 31, and then outputs the processed image to the vehicle recognition unit 16, the white-line recognition unit 17, and the pedestrian recognition unit 18.

The vehicle recognition unit 16 recognizes a vehicle by performing pattern matching over the image output by the pre-processing unit 11, and outputs a recognition result to the collision determining unit 20. The white-line recognition unit 17 recognizes a white line by performing pattern matching over the image output by the pre-processing unit 11, and outputs a recognition result to the collision determining unit 20.

The pedestrian recognition unit 18 is configured to recognize a pedestrian image from the image output by the pre-processing unit 11 (input image), and includes a cutting-out unit 18a, an interval setting unit 18b, and a recognition processing unit 18c.

The cutting-out unit 18a performs processing of cutting out a determination subject area from the input image. The interval setting unit 18b is a unit that controls a cutting-out interval for a determination subject area cut out by the cutting-out unit 18a. The recognition processing unit 18c performs processing of recognizing presence of a pedestrian by comparing an image within the cut-out determination subject area with a template.

The collision determining unit 20 determines a risk of a collision between the vehicle in operation and a pedestrian or another vehicle by using recognition results obtained by the vehicle recognition unit 16, the white-line recognition unit 17, and the pedestrian recognition unit 18, a detection result obtained by the radar 33, and positional information output by the navigation device 30.

Specifically, the collision determining unit 20 determines a probability of the occurrence of a collision with a pedestrian or another vehicle, a time of the collision, a distance to a predicted location of the collision, and an angle of the collision, and based on determination results, then outputs to the pre-crash ECU 40 an information displaying instruction for the display device 43, a warning audio-output instruction for the speaker 44, a braking control instruction, and an EFI control instruction.

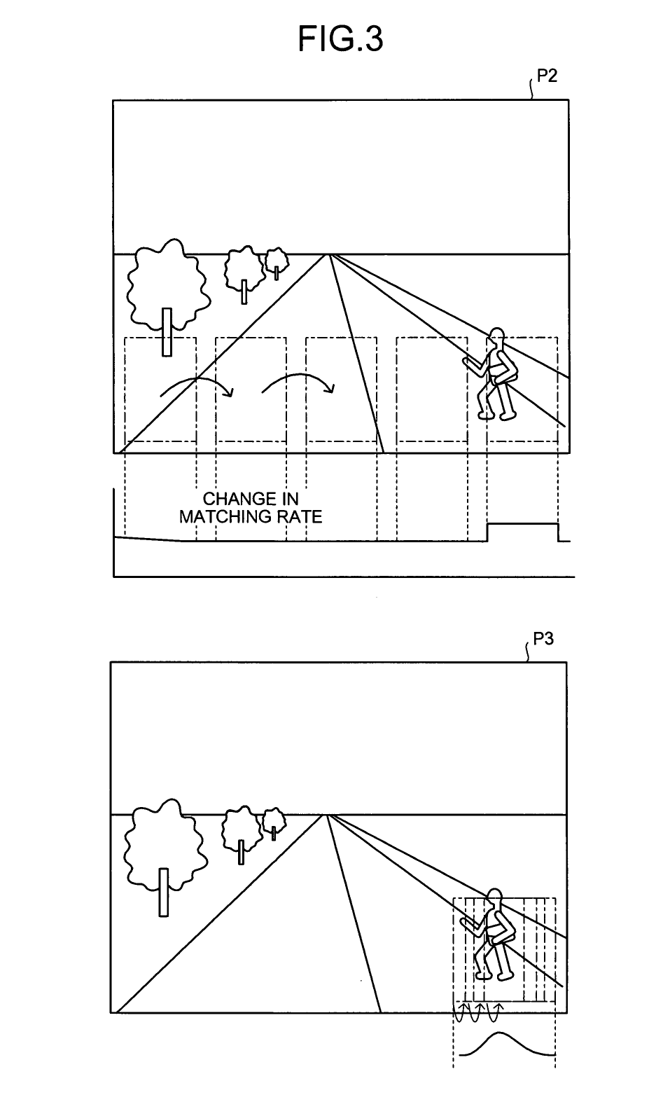

Cutting-out interval control for a determination subject area is further explained. As shown in FIG. 3, if a pedestrian is present in the lower part of an image P2, a broad location where a pedestrian is possibly present can be obtained by performing pattern matching over a determination subject area cut out with a relatively large interval, and acquiring a change in the degree of matching (matching rate). In other words, a search (sampling) interval is large in the image P2, so that a matching rate takes rough values.

As shown on an image P3 in FIG. 3, surroundings of a determination subject area having a relatively high matching degree are then cut out with transversely small intervals (across the x axis direction of the image, i.e., the direction horizontal to the ground, and orthogonal to the traveling direction of the vehicle), and pattern matching is performed over cut out areas, thereby searching for a location at which the matching rate is peaked across the transverse direction. In other words, a search interval is small in the image P3, and matching rates can be examined strictly, so that a peak value can be detected in detail.

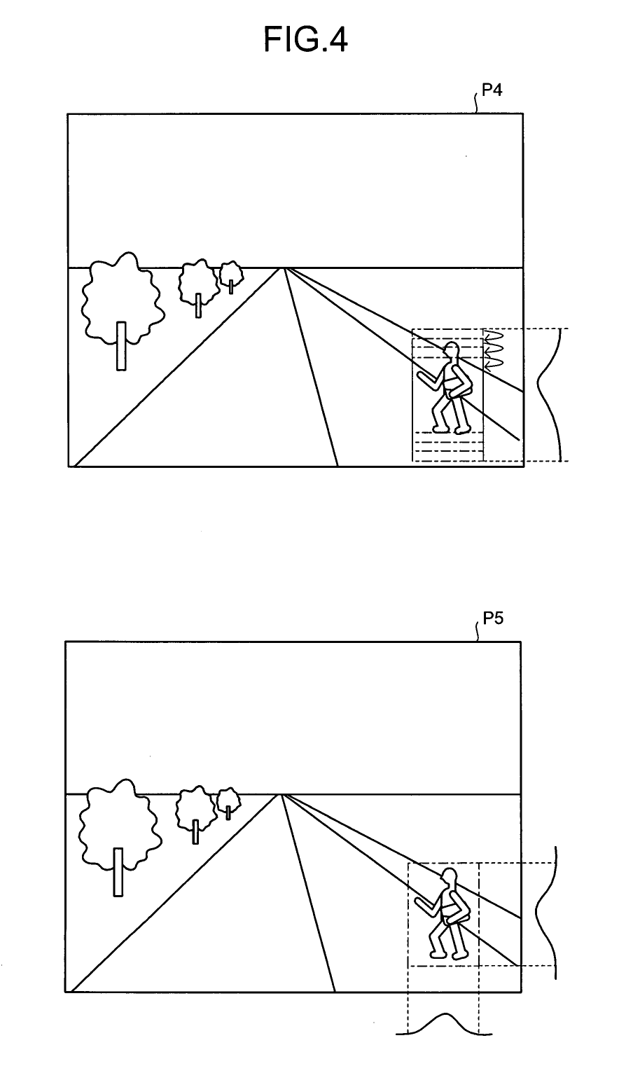

As shown in an image P4 in FIG. 4, cutting-out is then performed with vertically small intervals (across the y axis direction of the image, i.e., a combined direction of the direction vertical to the ground and the traveling direction of the vehicle), and pattern matching is performed to search for a location at which the matching rate is peaked in the vertical direction, consequently, a determination subject area including the whole pedestrian image can be cut out as shown in FIG. P5.

Here, pedestrian recognition uses a plurality of templates, and often determines a pedestrian if the matching rate with any of the templates is equal to or higher than a predetermined value. In such case, after a determination subject area is determined in which a pedestrian is present according to any of the templates, the determination subject area is excluded from cutting-out after that (pattern matching with other templates is omitted), so that a computing volume can be further reduced.

Pedestrian recognition is executed per image-shot by the camera 31 (for example, per few milliseconds). By preferentially cutting out an area in the vicinity of a location at which a pedestrian is recognized in the previous input image, pedestrian recognition can be speeded up.

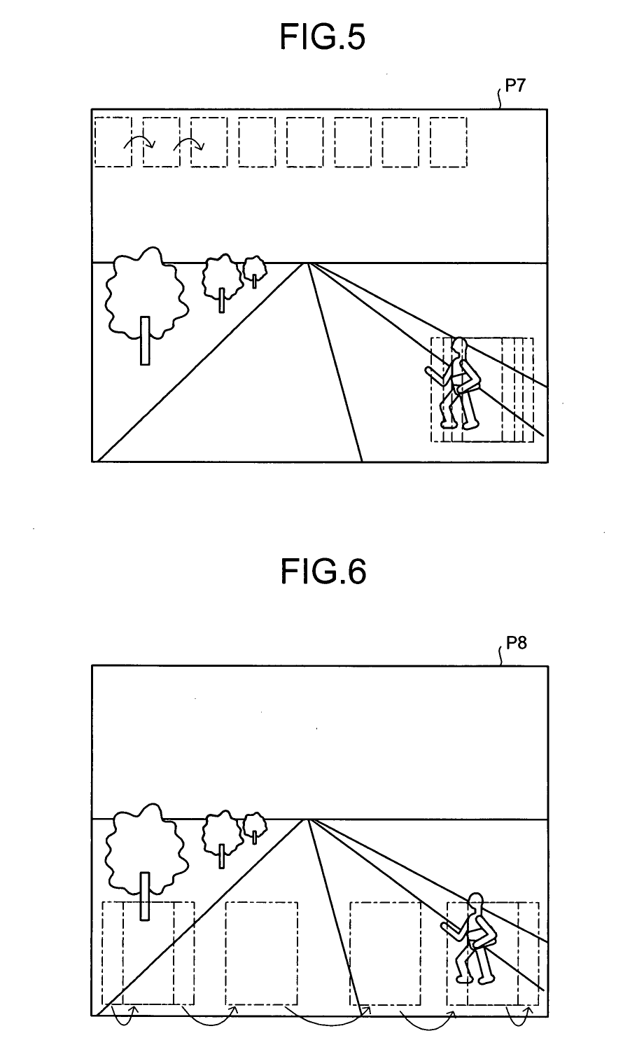

For example, on an image P7 in FIG. 5, a pedestrian is present lower right in the previously shot image. Because the shooting interval of the camera 31 is sufficiently short compared with a moving speed of a pedestrian, the pedestrian is highly likely present in a location near the previous location in the image P7.

Accordingly, for cutting-out determination subject areas in the image P7, first of all, determination subject areas with small intervals are cut out in lower right part where a pedestrian is present in the previous image, and then determination subject areas are cut out with normal intervals in the normal order (from upper left in the figure).

When a pedestrian newly appears in the image, the pedestrian highly likely appears from the left end or the right end of a shoot image. Therefore, as shown in an image P8 in FIG. 6, when a determination subject area is cut out from the vicinities of the left and right ends of the input image, it is desirable to take small cutting-out intervals.

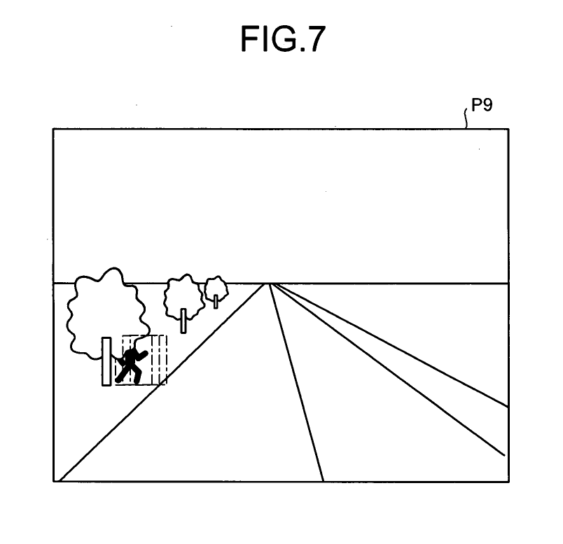

Similarly, because it is conceivable that a pedestrian suddenly appears from a shade of an object, as shown as an image P9 in FIG. 7, if the object, i.e., an object that can block a pedestrian, such as another vehicle, a building, or a tree, has been recognized, it is desirable to take small cutting-out intervals in the vicinity of the object. To recognize the object, image recognition performed by the vehicle recognition unit 16 or output from the radar 33 can be used.

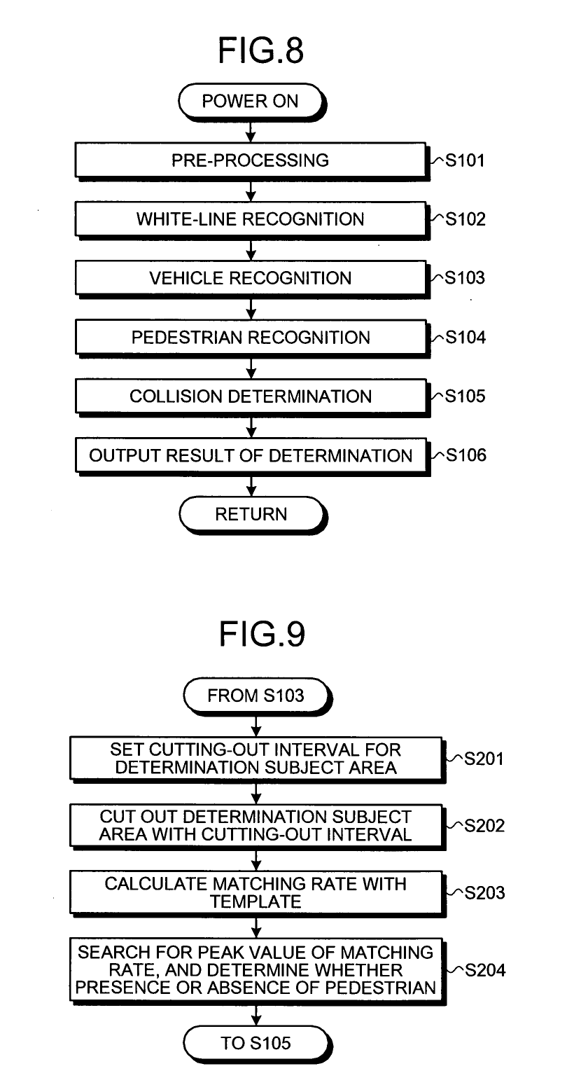

In the following description, an operation of overall processing performed by the image recognition apparatus 10 shown in FIG. 2 is explained with reference to FIG. 8. A processing flow shown in the figure is processing to be started when the power is switched on (which can be worked in parallel with an ignition switch) and the camera 31 shoots an image, and to be repeatedly executed for processing of each image frame (for example, per few milliseconds).

To begin with, the image recognition apparatus 10 performs processing with the pre-processing unit 11, such as filtering, edge detection, and contour extraction, on an image shot by the camera 31 (step S101). In the next step, white-line recognition is executed by the white-line recognition unit 16 (step S102), and vehicle recognition is executed by the vehicle recognition unit 16 (step S103).

After that, the pedestrian recognition unit 18 executes pedestrian recognition (step S104), and the collision determining unit 20 performs collision determination (step S105), outputs a determination result to the pre-crash ECU 40 (step S106), and terminates the processing.

Specific processing details performed by the pedestrian recognition unit 18 described as step S104 are shown in FIG. 9. As shown in the figure, at first, the pedestrian recognition unit 18 sets a cutting-out interval with the interval setting unit 18b (step S201), and cuts out a determination subject area with the cutting-out processing unit 18a in accordance with the set cutting-out interval (step S202). As a determination subject area, an exceptional image left by subtracting a background image is considered as a candidate area, and an area surrounding the candidate area becomes a determination subject.

In the next step, the recognition processing unit 18c calculates a matching rate with a template (step S203), searches for the peak value of matching rates, i.e., a value of the matching rate in a state where a pedestrian completely enters into the determination subject area, compares the peak value and a threshold, determines whether presence or absence of a pedestrian according to whether the peak value exceeds the threshold (step S204), and then terminates the processing. It is determined at recognition according to whether a degree of matching (%) in shape exceeds the determination threshold.

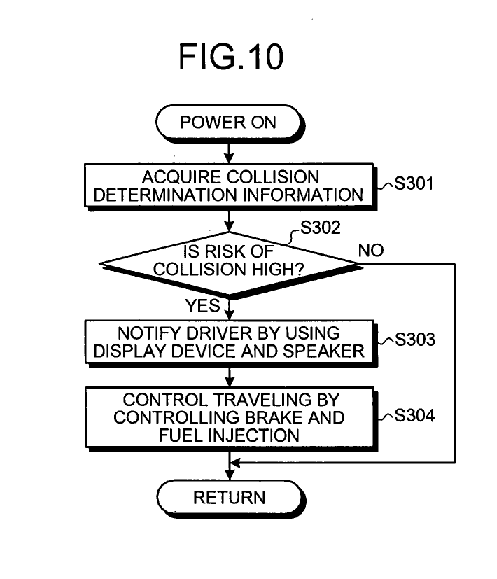

In the following description, a processing procedure performed by the pre-crash ECU 40 is explained with reference to a flowchart shown in FIG. 10. A processing flow shown in the figure is processing to be repeatedly executed during the operation of the pre-crash ECU 40.

To begin with, the pre-crash ECU 40 acquires a collision determination result from the image recognition apparatus 10 as collision determination information (step S301). If a risk of collision is high (Yes at step S302), the pre-crash ECU 40 notifies the driver by using the display device 43 and the speaker 44 (step S303), controls the traveling state of the vehicle in operation by controlling the brake 41 and the EFI 42 (step S304), and terminates the processing.

As described above, when cutting out a determination subject area from an image shot by the camera, the image recognition apparatus 10 according to the first embodiment controls an intervals for cutting out based on a location of the determination subject area in the input image, so that a computing volume can be reduced while maintaining precision in pattern matching, and recognition processing can be speeded up.

In addition to a cutting-out interval, a size of a determination subject area can be controlled in accordance with a location in the image.

The first embodiment has been explained in a case where recognition is performed by pattern matching. However, the present invention is not limited to this, but can be applied to an arbitrary recognition method by which recognition is performed by cutting out a determination subject area.

Similarly, the first embodiment has been explained in a case where a pedestrian is recognized as a specific object. However, the first embodiment can be applied to recognition of any other object, for example, a dropped object on a road.

### Second Embodiment

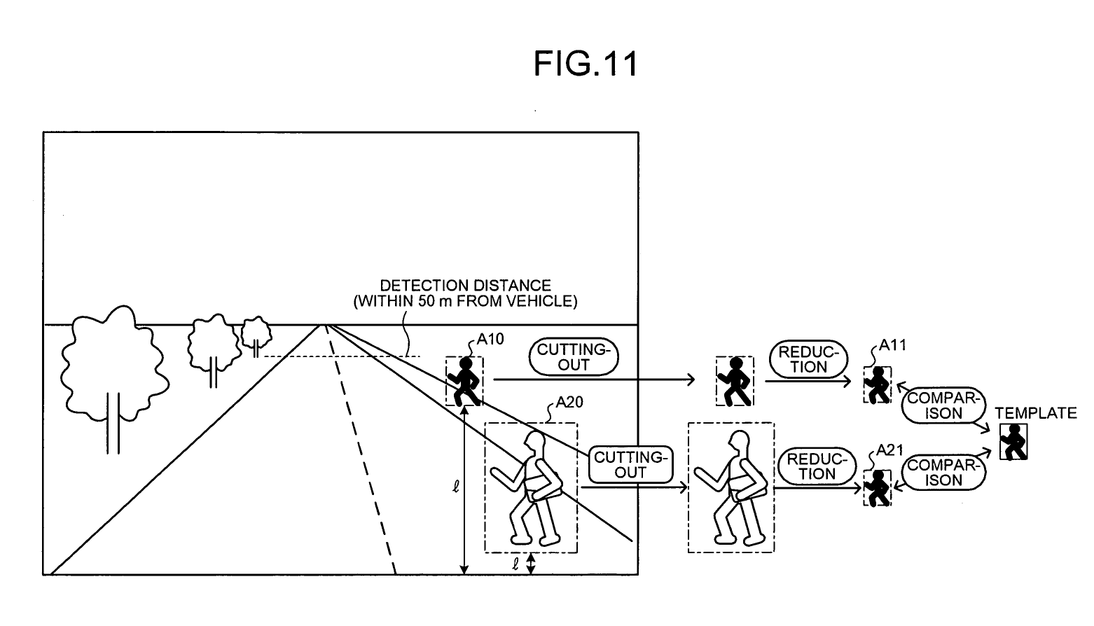

First of all, an image recognition method according to the present invention is explained below with reference to FIG. 11. In the second embodiment, an image of a pedestrian present in a location at a predetermined distance from the vehicle is used as a template. In this case, the predetermined distance is preferably the longest distance along which pedestrian recognition is required, i.e., a maximum distance (detection distance) at which a pedestrian should be detected from the vehicle, for example, approximately 50 meters. Accordingly, the vehicle recognizes a pedestrian present within 50 meters from the vehicle, and gives a warning.

Determination subject areas A10 and A20 are then cut out from an image shot by an on-vehicle camera shown in FIG. 11, and are reduced in size in accordance with the size of a template into reduced images A11 and A12, respectively. If the reduced images A11 and A12 are matched with the template by comparison, it is determined that the reduced images are pedestrians.

Here, a reduction rate is determined based on a location of a cut-out determination subject area in the input image, specifically, based on a height of the bottom of a determination subject area in the input image.

If a pedestrian image is included in the input image, the location of a footing of the pedestrian corresponds to a distance from the vehicle, so that the shorter distance from the vehicle to the pedestrian is the larger size of the pedestrian image within the input image. For this reason, a distance from the vehicle can be estimated by assuming that the bottom of a determination subject area is the footing of the pedestrian, and then a reduction rate required for matching with the size of a template, precisely, the size of a pedestrian at a predetermined distance (for example, 50 meters) from the vehicle, can be obtained.

By calculating a reduction rate in this way, searching for an optimal enlargement/reduction rate by successively changing the rate is not required, as a result, a processing load can be largely reduced and a processing speed can be enhanced.

At the longer distance from the vehicle to the pedestrian, it is more difficult to find out a difference in appearance, such as clothes, and a weight of information about the contour is larger in the pedestrian image. For this reason, a pedestrian image at a long distance is used as a template, a determination subject area is reduced in size, and the both are compared with each other, as a result, the processing can have an effect of filtering for leaving out individual differences.

In addition, a pedestrian image at a long distance is small in size, as a result, a storage medium volume required for storing therein templates can be reduced, and if a storage medium has a sufficient capacity, patterns of templates can be increased, so that recognition precision can be improved.

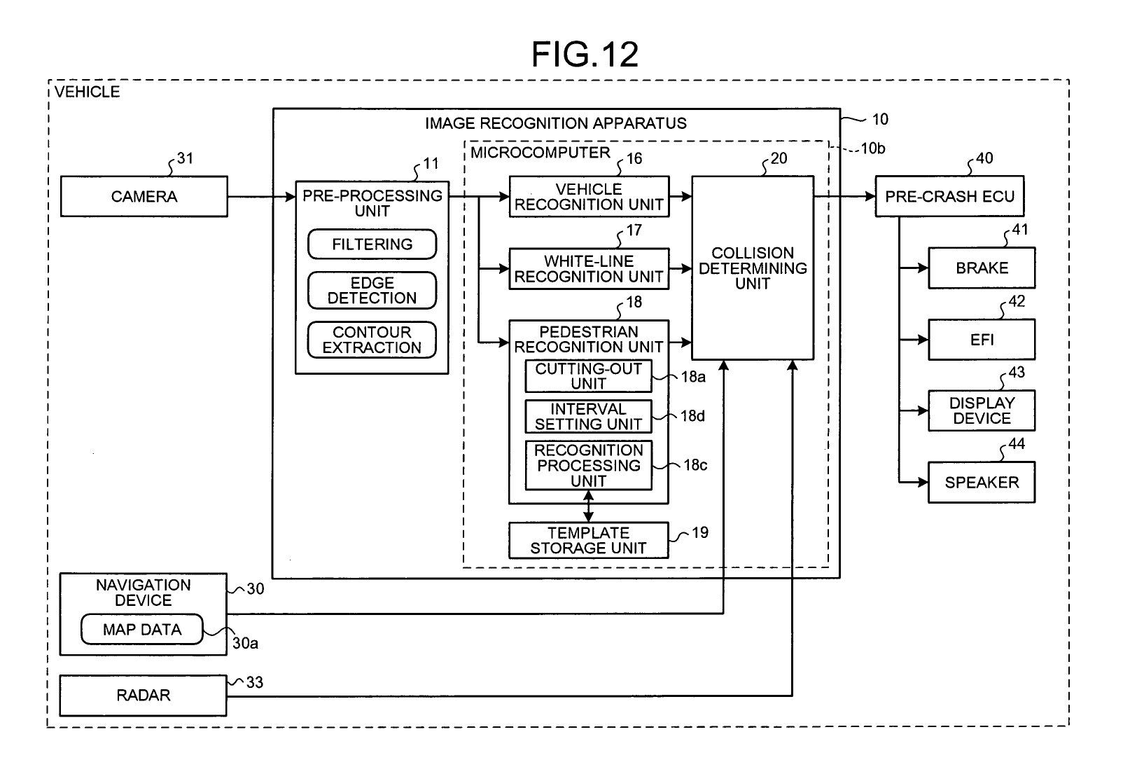

In the following description, an outline configuration of the image recognition apparatus 10 configured to be installed on a vehicle according to the embodiment is explained with reference to FIG. 12. As shown in the figure, the image recognition apparatus 10 installed on a vehicle is connected to the navigation device 30, the camera 31, the radar 33, and the pre-crash ECU 40.

The navigation device 30 is an on-vehicle device that sets and guides a driving route by using a location of the vehicle specified by communicating with the GPS (Global Positioning System) and the map data 30a that is stored in advance in the navigation device 30. Moreover, the navigation device 30 provides information to the image recognition apparatus 10, for example, positional information about the vehicle, map information about surroundings, and a planned driving route.

The camera 31 shoots surroundings of the vehicle, and inputs a shot result into the image recognition apparatus 10. The radar 33 detects an object around the vehicle, measures a distance to the object, and inputs the measured distance into the image recognition apparatus 10.

The pre-crash ECU 40 is an electronic control device that is to be controlled by the image recognition apparatus 10 when the image recognition apparatus 10 predicts a collision of the vehicle, and executes operation control of the vehicle with the brake 41 and the engine control device (EFI) 42, and notification with the display device 43 or the speaker 44.

The display device 43 is an output unit that gives a displayed notice to a user, i.e., an occupant in the vehicle, and the speaker 44 is an output unit that gives an audio notice. The display device 43 and the speaker 44 makes an output by being controlled by the pre-crash ECU 40, and can be shared by various on-vehicle devices, such as the navigation device 30, and an on-vehicle audio device, which is not shown.

The image recognition apparatus 10 includes therein the pre-processing unit 11, the vehicle recognition unit 16, the white-line recognition unit 17, the pedestrian recognition unit 18, a template storage unit 19, and the collision determining unit 20. Here, it is preferable that the vehicle recognition unit 16, the white-line recognition unit 17, the pedestrian recognition unit 18, the template storage unit 19, and the collision determining unit 20 are implemented, for example, by a single microcomputer 10b (a computing unit that includes a combination of a CPU, a ROM, and a RAM).

The pre-processing unit 11 performs processing, such as filtering, edge detection, and contour extraction, on an image shot by the camera 31, and then outputs the processed image to the vehicle recognition unit 16, the white-line recognition unit 17, and the pedestrian recognition unit 18.

The vehicle recognition unit 16 recognizes a vehicle by performing pattern matching over the image output by the pre-processing unit 11, and outputs a recognition result to the collision determining unit 20. The white-line recognition unit 17 recognizes a white line by performing pattern matching over the image output by the pre-processing unit 11, and outputs a recognition result to the collision determining unit 20.

The pedestrian recognition unit 18 is configured to recognize a pedestrian image from the image output by the pre-processing unit 11 (input image), and includes the cutting-out unit 18a, a reduction processing unit 18d, and the recognition processing unit 18c.

The cutting-out unit 18a performs processing of cutting out a determination subject area from the input image. The reduction processing unit 18d calculates a reduction rate from the height of a cut-out determination subject area in the input image, and creates a reduced image. The recognition processing unit 18c performs recognition of presence of a pedestrian by comparing the reduced image with a template stored in the template storage unit 19.

The template storage unit 19 prestores therein a template to be used for pedestrian recognition, precisely, images of a pedestrian present at a predetermined distance from the vehicle. The template storage unit 19 can also store therein templates for other recognition, such as vehicle recognition, as well as the template for pedestrian recognition. In practice, a shape of a pedestrian positioned at a detection distance 50 meters is shot by a camera, cut out, and stored. There can be a plurality of templates for pedestrian recognition.

The collision determining unit 20 determines a risk of a collision between the vehicle in operation and a pedestrian or another vehicle by using recognition results obtained by the vehicle recognition unit 16, the white-line recognition unit 17, and the pedestrian recognition unit 18, a detection result obtained by the radar 33, and positional information output by the navigation device 30.

Specifically, the collision determining unit 20 determines a probability of the occurrence of a collision with a pedestrian or another vehicle, a time of the collision, a distance to a predicted location of the collision, and an angle of the collision, and based on determination results, then outputs to the pre-crash ECU 40 an information displaying instruction for the display device 43, a warning audio-output instruction for the speaker 44, a braking control instruction, and an EFI control instruction.

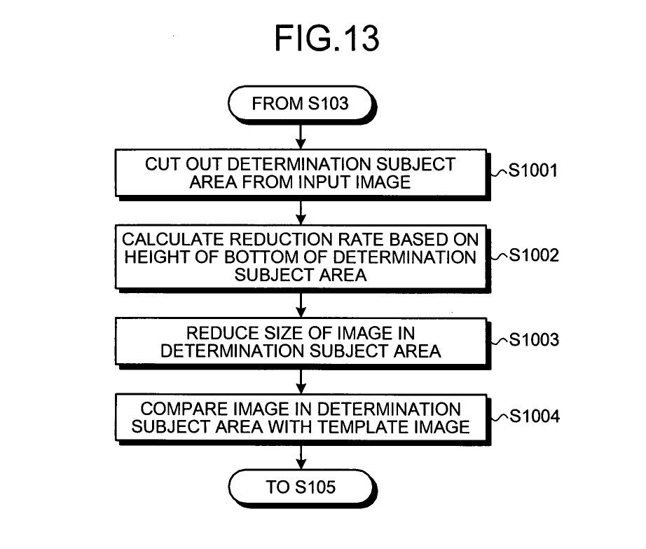

An overall processing procedure performed by the image recognition apparatus shown in FIG. 12 is the same as the operation shown with reference to FIG. 8 in the first embodiment, therefore explanation for is omitted here. Specific processing details performed by the pedestrian recognition unit 18 described as step S104 in FIG. 8 are shown in FIG. 13. As shown in the figure, at first, the pedestrian recognition unit 18 cuts out a determination subject area with the cutting-out unit 18a (step S1001). As a determination subject area, an exceptional image left by subtracting a background image is considered as a candidate area, and an area surrounding the candidate area becomes a determination subject.

In the next step, the reduction processing unit 18d calculates a reduction rate based on the height of the bottom of the cut-out determination subject area in the input image (step S1002), reduces the image in the determination subject area in size, and creates a reduced image (step S1003).

After that, the recognition processing unit 18c performs processing of recognizing presence of a pedestrian by comparing the reduced image with a template stored in the template storage unit 19 (step S1004), and terminates the processing. It is determined at recognition according to whether a degree of matching (%) in shape exceeds a determination threshold.

The processing procedure performed by the pre-crash ECU 40 is the same as the operation explained with reference to FIG. 10 in the first embodiment, therefore explanation for it is omitted.

As described above, the image recognition apparatus 10 according to the second embodiment uses an image of a pedestrian present at a predetermined distance from the vehicle as a template, and reduces in size a determination subject area from an image shot by an on-vehicle camera in accordance with the size of the template, and performs comparison. As a result, recognition precision is improved by reducing a storage medium volume required for storing therein templates, and by increasing patterns of templates if a storage medium has a sufficient capacity, and recognition precision is also improved by using the reduction processing as filtering for leaving out individual differences among pedestrians.

In addition, because a distance from the vehicle is estimated by assuming that the bottom of a cut-out determination subject area is the footing of a pedestrian, and a reduction rate required for matching with the size of a template is calculated, searching for an optimal enlargement/reduction rate by successively changing the rate is not required, as a result, a processing load can be largely reduced and a processing speed can be enhanced.

### INDUSTRIAL APPLICABILITY

As described above, the image recognition apparatus, the image recognition method, and the vehicle control apparatus according to the present invention is effective for image recognition performed on a vehicle, particularly suitable for reducing a load of recognition processing.

### BRIEF DESCRIPTION OF THE DRAWINGS

[FIG. 1] A schematic diagram for explaining an image recognition method according to the present invention, particularly cutting-out of a determination area.

[FIG. 2] An outline configuration diagram that depicts an outline configuration of an image recognition apparatus according to a first embodiment of the present invention.

[FIG. 3] A schematic diagram for explaining a search for a peak value of matching rates (part 1).

[FIG. 4] A schematic diagram for explaining a search for a peak value of matching rates (part 2).

[FIG. 5] A schematic diagram for explaining cutting-out control by using a result of the previous recognition.

[FIG. 6] A schematic diagram for explaining control when taking small cutting-out intervals on left and right ends of a screen.

[FIG. 7] A schematic diagram for explaining control when taking a small cutting-out interval in the vicinity of a blocking object.

[FIG. 8] A flowchart for explaining a processing procedure performed by an image recognition apparatus 10.

[FIG. 9] A flowchart for explaining a detailed processing procedure for a pedestrian recognition process according to the first embodiment.

[FIG. 10] A flowchart for explaining a processing procedure performed by a pre-crash ECU 40.

[FIG. 11] A schematic diagram for explaining an image recognition method according to the present invention, particularly a pattern matching method.

[FIG. 12] An outline configuration diagram that depicts an outline configuration of an image recognition apparatus according to a second embodiment of the present invention.

[FIG. 13] A flowchart for explaining a detailed processing procedure for a pedestrian recognition process according to the second embodiment.

### EXPLANATIONS OF LETTERS OR NUMERALS

10 Image recognition apparatus
10a, 10b Microcomputer
16 Vehicle recognition unit
17 White-line recognition unit
18 Pedestrian recognition unit
18a Cutting-out unit
18b Interval setting unit
18c Recognition processing unit
18d Reduction processing unit
20 Collision determining unit
30 Navigation device
30a Map data
31 Camera
33 Radar
40 Pre-crash ECU
41 Brake
42 EFI
43 Display device
44 Speaker

1.-13. (canceled)

14. An apparatus for recognizing an image, comprising:
an extracting unit that extracts a determination subject area from an input image shot by a camera;
a recognition unit that recognizes a presence of a specific object by comparing an image of the determination subject area with a reference image; and
an interval control unit that controls an interval of an extracting position of the determination subject area to be extracted by the extracting unit based on a location of the determination subject area within the input image.

15. The apparatus according to claim 14, wherein the interval control unit takes an extracting interval lager when extracting a determination area from a lower part of an image than when extracting from an upper part of the image, based on a vertical location of the determination subject area in the input image.

16. The apparatus according to claim 14, wherein the interval control unit takes an extracting interval smaller when extracting a determination area from vicinities of a left edge and a right edge of the input image.

17. The apparatus according to claim 14, wherein when an object having a possibility of blocking the specific object is already recognized, the interval control unit takes an extracting interval smaller in a vicinity of the object.

18. The apparatus according to claim 14, wherein when the recognition unit uses a plurality of reference images, the interval control unit excludes an area where the specific object is determined to be present based on any one of the reference images from subsequent extraction.

19. The apparatus according to claim 14, wherein when an image recognition is successively performed on input images shot in time-series, the interval control unit takes an extracting interval smaller in a vicinity of a location where the specific object is recognized in a previous input image.

20. The apparatus according to claim 14, wherein the interval control unit causes an extraction with a smaller extraction interval to be performed again in a vicinity of a location where a degree of matching with the reference image is determined to be relatively high by a recognition processing performed by the recognition unit.

21. The apparatus according to claim 14, wherein the specific object is a pedestrian.

22. A method of recognizing an image, comprising:
extracting a determination subject area from an input image shot by a camera;
recognizing a presence of a specific object by comparing an image of the determination subject area with a reference image; and
controlling an interval of an extracting position of the determination subject area to be extracted at the extracting based on a location of the determination subject area within the input image.

23. A vehicle control apparatus comprising:
an extracting unit that extracts a determination subject area from an input image shot by a camera;
a recognition unit that recognizes a presence of a specific object by comparing an image of the determination subject area with a reference image;
an interval control unit that controls an interval of an extracting position of the determination subject area to be extracted by the extracting unit based on a location of the determination subject area within the input image; and
a control unit that performs at least one of a notification control to a driver and a traveling control to control a traveling state of a vehicle, based on a result of recognition by the recognition unit.

24. An apparatus for recognizing an image, comprising:
a reduction unit that reduces a size of an image that is to be a determination subject area in an input image shot by a camera; and
a recognition unit that recognizes a presence of a specific object by comparing an image obtained by the reduction unit with a reference image, wherein
a size of the reference image corresponds to a size of the specific object when the specific object is present at a maximum detection distance of the recognition unit.

25. The apparatus according to claim 24, wherein the reduction unit determines a reduction rate based on a location of the determination subject area in the input image.

26. A method of recognizing an image, comprising:
reducing a size of an image that is to be a determination subject area in an input image shot by a camera; and
recognizing a presence of a specific object by comparing an image obtained at the reducing with a reference image, wherein
a size of the reference image corresponds to a size of the specific object when the specific object is present at a maximum detection distance of the reducing.
